(19) United States
(12) Patent Application Publication
(10) Pub. No.: US 2025/0380138 A1
(43) Pub. Date: Dec. 11, 2025

(54) Method and Device for Data Exchange Between a Motor Vehicle and a User Terminal

(71) Applicant: Bayerische Motoren Werke Aktiengesellschaft, Muenchen (DE)

(72) Inventor: Matthias Fink, Muenchen (DE)

(21) Appl. No.: 19/215,500

(22) Filed: May 22, 2025

(30) Foreign Application Priority Data
Jun. 5, 2024 (DE) 10 2024 115 731.3

(51) Int. Cl. H04W 12/069; H04W 4/40; H04W 48/14

(52) U.S. Cl. CPC H04W 12/069; H04W 4/40; H04W 48/14

(57) ABSTRACT

The present disclosure relates to a method and a device for data exchange between a motor vehicle and a user terminal, wherein the method comprises: determining data to be provided by a motor vehicle to a user terminal, detecting an approach of the user terminal to the motor vehicle, wherein the user terminal comprises a digital access key for the motor vehicle, and performing an authentication process between the user terminal and the motor vehicle in response to the approach to provide the digital access key to the motor vehicle, wherein the authentication process includes providing the determined data to the user terminal.

### CROSS REFERENCE TO RELATED APPLICATION

This application claims priority under 35 U.S.C. § 119 from German Patent Application No. 10 2024 115 731.3, filed Jun. 5, 2024, the entire disclosure of which is herein expressly incorporated by reference.

### BACKGROUND AND SUMMARY

The present disclosure relates to a method and a device for data exchange between a motor vehicle and a user terminal.

A system for data exchange between at least one vehicle and at least one mobile terminal is known. for example, from publication DE 10 2014 203 060 A1.

An object of the invention is to provide an improved method and an improved device for data exchange between a motor vehicle and a user terminal.

This object is achieved according to forms of the invention by the independent claims. Advantageous embodiments of the invention are the subject of the dependent claims and the description.

A first aspect of a method according to the invention for data exchange between a motor vehicle and a user terminal comprises the steps of determining data to be provided by a motor vehicle to a user terminal, detecting an approach of the user terminal to the motor vehicle, wherein the user terminal comprises a digital access key for the motor vehicle, and performing an authentication process between the user terminal and the motor vehicle in response to the approach or recognition of the approach in order to provide the digital access key to the motor vehicle, wherein the authentication process includes providing the determined data to the user terminal.

The method according to the invention serves in particular for exchanging data between a motor vehicle and a user terminal. According to a first aspect, data are provided by a motor vehicle to a user terminal and, if necessary, further to a remote computing device; according to a second aspect, data are provided from a user terminal to a motor vehicle, wherein in the second aspect, the data were previously provided to the user terminal by a remote computing device.

A common feature of both aspects is that the data exchange takes place as part of an authentication process involving the use of a digital key between the user terminal and the motor vehicle. Thus, the invention in particular uses a secure process in which the motor vehicle and the user terminal have authenticated each other in order to exchange data within this context. This is in particular a unidirectional data exchange—i.e., data are provided either exclusively from the motor vehicle to the user terminal or exclusively from the user terminal to the motor vehicle.

The user terminal is a portable or mobile device assigned in particular to a user of the motor vehicle, such as a driver, holder, or owner, and is distinct from the motor vehicle. The user terminal may be, for example, a mobile phone, smartphone, phablet, tablet, and/or wearable, such as a smartwatch, Fitbit, and/or smart glasses.

The user terminal is used in particular, but not exclusively, to provide interaction and especially access functions for the motor vehicle. To that end, the user terminal includes a digital key that enables such functions securely. The digital key is in particular a unique character string that uniquely identifies the user terminal and/or the user and is authenticated by the motor vehicle based on a secure, especially encrypted, method.

According to the first aspect, data to be transmitted from the motor vehicle to the user terminal are first determined.

These data are selected in particular by the motor vehicle and/or at the initiative of the motor vehicle. The data may include in particular usage data of the motor vehicle, such as diagnostic data, maintenance data, condition data, and/or wear data. For example, the data may include error messages, maintenance information, internal states, and/or diagnostic evaluations compiled by the motor vehicle, especially since the last execution of the method.

Then, an approach of the user terminal to the motor vehicle is detected.

Such an approach can be detected in particular via one or more near-field communication protocols, such as Bluetooth, especially Bluetooth LE, UWB, NFC, and/or RFID. In such cases, one or more transceivers of the motor vehicle and/or the user terminal typically and regularly, periodically, and/or continuously search for other transceivers in the vicinity and establish wireless data communication upon finding and especially recognizing the other transceiver, particularly via one or more of the aforementioned near-field communication protocols.

In particular, an approach of the user terminal to the motor vehicle of less than 100 m, 50 m, 25 m, 10 m, or 5 m is detected.

In response to the approach, especially in response to the approach within a predetermined distance and particularly after wireless data communication between the user terminal and the motor vehicle has been established, an authentication process between the user terminal and the motor vehicle is carried out to provide the digital access key to the motor vehicle. Distance measurement may be implemented using methods known from the prior art. such as based on Bluetooth technology and/or UWB radio technology, for example by means of RSSI (Received Signal Strength Indicator) and/or trilateration and/or triangulation.

In this authentication process, predetermined data are exchanged in particular, including one or more keys—especially the digital access key and/or related information. Specifically, in response to authentication and/or provision of the digital access key, the motor vehicle is also unlocked, especially one or more doors of the motor vehicle.

Additionally and according to the invention, the data previously determined for data exchange are also exchanged or provided by the motor vehicle to the user terminal in connection with this authentication process.

In particular, these previously determined data are provided in response to the authentication process. Likewise, these previously determined data are exchanged before the authentication process is completed or immediately thereafter, especially before other data are exchanged between the user terminal and the motor vehicle.

Solutions according to the invention makes it possible to exchange data as part of an authentication process between a motor vehicle and a user terminal. In particular, a communication channel that is especially secure is used for the data exchange, which is established or used especially each time the user approaches the motor vehicle.

According to a further development, the determined data are provided to a secure element of the user terminal.

Thus, according to this further development, the previously determined data are provided to or stored in the secure element of the user terminal after data transfer from the motor vehicle to the user terminal.

A secure element is for example a specially secured operating system based on a tamper-resistant hardware component and/or a secured memory area. It is used to protect values and/or information—such as keys, digital certificates, access authorizations, and/or other sensitive data—from unauthorized access.

The secure element is in particular isolated from the rest of the memory area and/or operating system of the user terminal and operates, for example, in a controlled environment that cannot be accessed or affected by software from other areas of a general-purpose operating system of the user terminal. The secure element in particular includes a power supply that is separate from the rest of the user terminal or self-sufficient. In particular, the secure element and/or the data exchange continues to function even when the user terminal is switched off and/or has a low battery charge.

Thus, according to this further development, the data are provided to or stored in the secure element when transferred from the motor vehicle to the user terminal—especially immediately after provision by the motor vehicle to the user terminal. In particular, the data are provided exclusively and/or at least first to the secure element or stored therein.

This further development enables a particularly secure and especially fail-safe data exchange.

According to a further, second aspect, a method is provided for data exchange between a motor vehicle and a user terminal, comprising the steps of: determining data to be provided by a user terminal to a motor vehicle; detecting an approach of the user terminal to the motor vehicle. wherein the user terminal comprises a digital access key for the motor vehicle; performing an authentication process between the user terminal and the motor vehicle in response to the approach to provide the digital access key to the motor vehicle; wherein the authentication process includes providing the determined data to the motor vehicle.

Thus, this second aspect describes data communication in the opposite direction.

The data to be provided from the user terminal to the motor vehicle are selected in particular by the user terminal and/or on the initiative of the user terminal. These data may particularly include usage data of the motor vehicle, such as user configuration data, maintenance data, settings data, and/or key data. For example, the data may include user preferences, maintenance information, and/or key information that are to be provided to the motor vehicle, especially since the last execution of the method. In particular, the data may include key data or key information for setting up an additional digital access key for another device that is different from the user terminal.

In particular, the data may be further processed after being provided to the motor vehicle. For example, user preferences such as an interior temperature and/or climate setting, a radio station and/or music selection, and/or a seat position may be set or applied to the motor vehicle. Likewise, a digital access key may be set up for an additional, second user terminal. The further processing may in particular take place immediately in response to the provision. For example, the further processing of the data may be completed before or by the time a door, in particular the driver's door, of the motor vehicle is opened.

It is understood that both aspects of the method—and in particular their further developments—may be carried out together, simultaneously, and/or consecutively.

In particular, data for data exchange may be determined both at the motor vehicle and at the user terminal, and then exchanged with each other in the context of the authentication process.

This solution also enables data to be exchanged as part of an authentication process between a motor vehicle and a user terminal. In particular, a communication channel that is especially secure is used for the data exchange, which is established or used especially each time the user approaches the motor vehicle.

According to a further development, the data are provided from a secure element of the user terminal.

The secure element is configured in particular as previously described.

Thus, according to this further development, the data are provided from or retrieved from the secure element when being transmitted from the user terminal to the motor vehicle—particularly immediately before the provision by the user terminal to the motor vehicle. In particular, the data are provided exclusively and/or at least finally from the secure element or retrieved from it.

This further development also enables a particularly secure and especially fail-safe data exchange.

The further developments described below in particular relate to both previously described aspects of the method according to the invention and/or may be carried out within this context.

According to a further development, the data were previously provided by a remote computing device.

According to this further development, the data determined for data exchange were previously provided by a remote computing device. In other words, according to this further development, the data to be provided from the motor vehicle to the user terminal are provided by a remote computing device to the motor vehicle and/or the data to be provided from the user terminal to the motor vehicle are provided by a remote computing device to the user terminal.

The determination of the data to be provided from the motor vehicle to the user terminal and/or from the user terminal to the motor vehicle is thus based on or in response to the data provided by the remote computing device.

In particular, the data to be provided from the user terminal to the motor vehicle are provided by the remote computing device to the secure element of the user terminal, in particular directly.

The remote computing device is, for example, configured as one or more server systems and/or partially or fully in a cloud and/or includes such components. The remote computing device may also be referred to as a backend.

The remote computing device communicates with the motor vehicle and/or the user terminal via one or more wireless communication protocols, in particular one or more far-field communication protocols, such as cellular networks—especially 3G, 4G, 5G—WiFi, and/or Car2X, especially Car2Infrastructure.

This further development is used in particular when the motor vehicle and/or the user terminal do not themselves have communication with the remote computing device before and/or during the execution of the method.

For example, the data are provided to the user terminal by the remote computing device and only provided from the user terminal to the motor vehicle when the motor vehicle has no communication with the remote computing device, particularly in response to the approach.

Likewise, for example, the data are provided to the motor vehicle by the remote computing device and only provided from the motor vehicle to the user terminal when the user terminal has no communication with the remote computing device, particularly in response to the approach.

This further development makes it possible to also provide data from a third party, such as the remote computing device, to the motor vehicle and/or the user terminal—especially when the motor vehicle and/or the user terminal do not have a direct connection to the remote computing device, for example because it is located in an underground garage and/or a dead zone.

According to a further development, the method further comprises the step of providing the data to a remote computing device.

According to this further development, the data that were provided from the motor vehicle to the user terminal are then provided by the user terminal to the remote computing device and/or the data that were provided from the user terminal to the motor vehicle are then provided by the motor vehicle to the remote computing device.

The provision may in particular take place as previously described via one or more wireless communication protocols, especially one or more far-field communication protocols.

In particular, the data to be provided from the user terminal to the remote computing device are provided from the secure element of the user terminal to the remote computing device—especially directly.

The computing device to which the data are provided according to this further development may be the same or a different computing device from the one that provided the data according to the previously described development.

This further development makes it possible to also provide data from the motor vehicle and/or the user terminal to a third party, such as the remote computing device—especially when the motor vehicle and/or the user terminal do not have a direct connection to the remote computing device, for example because it is located in an underground garage and/or a dead zone.

According to a further development, the data are not related to the authentication process.

In particular, the data that are transmitted—both from the motor vehicle to the user terminal and from the user terminal to the motor vehicle—are not used for the authentication process. Specifically, the content of the data is not intended for or useful in the authentication process. Likewise, the data are in particular not suitable for carrying out and/or supporting the authentication process.

According to a further development, the provision of the determined data includes signing the determined data.

In particular, according to this further development, the data to be provided from the motor vehicle to the user terminal and/or the data to be provided from the user terminal to the motor vehicle are signed.

The signing of the determined data is performed in particular by the unit or system that determines the data. This may be the motor vehicle, the user terminal, and/or the remote computing device.

The signing is performed in particular digitally and serves to ensure the integrity of the data. In particular, the signing is separate from the authentication process.

This further development enables particularly secure data communication.

According to a further development, the method further comprises the step of storing the data in a memory area designated for the digital access key.

In particular, under this further development, the data provided by the motor vehicle to the user terminal are stored on the user terminal, after being provided, in a memory area designated for the digital access key.

Likewise, according to this further development, the data to be provided by the user terminal to the motor vehicle are stored on the user terminal, before being provided, in a memory area designated for the digital access key.

The memory area designated for the digital access key is provided on the user terminal and serves in particular exclusively for the functions of providing the data according to the method of the invention and for providing the digital access key. This memory area is specifically a storage area that is logically and/or physically separated from the rest of the user terminal's memory, and in particular also features a dedicated power supply. This memory area is specifically included in and/or managed by the secure element.

This further development also enables a particularly secure and especially fail-safe data exchange.

According to another aspect, a device is provided for data exchange between a motor vehicle and a user terminal.

The device comprises means configured to carry out a method according to one of the previously described embodiments. In particular, the device includes one or more processor units for performing the above-described method. In addition, the device includes a memory, in particular a non-volatile memory, in which code is stored that, when executed by a processor unit, causes the execution of the above-described method.

Specifically, the device may include the user terminal, the motor vehicle, and/or the remote computing device, form a system with it, and/or interact with it to perform the above-described method.

Further features of the invention are apparent from the claims, the drawings, and the description of the drawings. The features and combinations of features mentioned in the description above and those mentioned in the description of the drawings and/or shown alone in the drawings may be used not only in the combinations stated, but also in other combinations or independently.

### BRIEF DESCRIPTION OF THE DRAWING

The invention will now be explained in more detail based on a preferred embodiment and with reference to the drawings.

FIG. 1 illustrates a schematic view of an embodiment of a device and a method for data exchange between a motor vehicle and a user terminal.

### DETAILED DESCRIPTION OF THE DRAWING

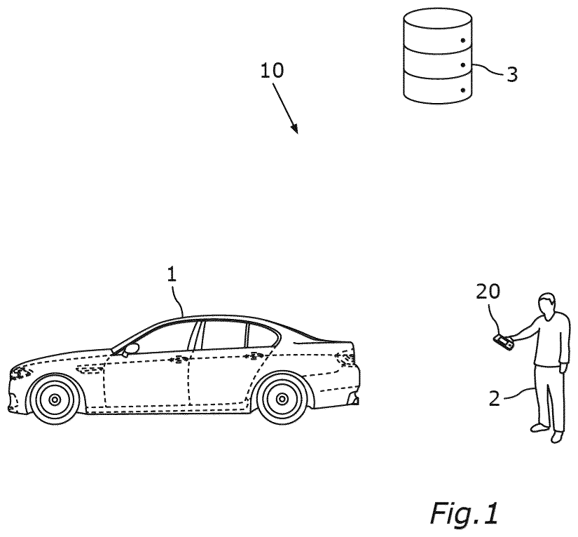

FIG. 1 shows a schematic view of an embodiment of a device 10 and a method for data exchange between a motor vehicle 1 and a user terminal 20 of a user 2.

The device 10 comprises means for carrying out or causing to carry out one or more steps of the method described below.

The device 10 is configured to determine data to be provided from the motor vehicle 1 to the user terminal 20.

The device 10 is also configured to detect an approach of the user terminal 20 to the motor vehicle 1, wherein the user terminal 20 comprises a digital access key for the motor vehicle 1.

The device 10 is also configured to perform an authentication process between the user terminal 20 and the motor vehicle 1 in response to the approach, to provide the digital access key to the motor vehicle 1.

The authentication process includes providing the determined data to the user terminal 20.

The determined data are provided to a secure element of the user terminal 20.

The device 10 is also configured to determine data to be provided by the user terminal 20 to the motor vehicle 1.

The device 10 is also configured to detect an approach of the user terminal 20 to the motor vehicle 1, wherein the user terminal 20 comprises a digital access key for the motor vehicle 1.

The device 10 is also configured to perform an authentication process between the user terminal 20 and the motor vehicle 1 in response to the approach, to provide the digital access key to the motor vehicle 1.

The authentication process includes providing the determined data to the motor vehicle 1.

The data are provided from a secure element of the user terminal 20.

The data to be provided by the user terminal 20 to the motor vehicle 1 were optionally previously provided to the user terminal by a remote computing device 3.

Likewise, the data to be provided by the motor vehicle 1 to the user terminal 20 were optionally previously provided to the motor vehicle 1 by the remote computing device.

The data provided to the user terminal are optionally subsequently provided to the remote computing device 3.

Likewise, the data provided to the motor vehicle are optionally subsequently provided to the remote computing device 3.

The data are not related to the authentication process.

The provision of the data optionally includes signing the data.

The device 10 is also configured to store the data in a memory area of the user terminal 20 designated for the digital access key.

### List of Reference Signs

1 Motor vehicle
10 Device
2 User
20 User terminal
3 Remote computing device

What is claimed is:

1. A method for data exchange between a motor vehicle and a user terminal, comprising:
determining data to be provided by a motor vehicle to a user terminal;
detecting an approach of the user terminal to the motor vehicle, wherein the user terminal comprises a digital access key for the motor vehicle; and
performing an authentication process between the user terminal and the motor vehicle in response to the approach to provide the digital access key to the motor vehicle;
wherein the authentication process includes providing the determined data to the user terminal.

2. The method of claim 1, wherein the determined data is provided to a secure element of the user terminal.

3. The method of claim 1, wherein the data was previously provided by a remote computing device.

4. The method of claim 1, further comprising:
providing the data to a remote computing device.

5. The method of claim 1, wherein the data is not related to the authentication process.

6. The method of claim 1, wherein providing the data includes signing the data.

7. The method of claim 1, further comprising:
storing the data in a memory area designated for the digital access key.

8. A Device for data exchange between a motor vehicle and a user terminal, wherein the device comprises means for performing a method according to claim 1.

9. A method for data exchange between a motor vehicle and a user terminal, comprising:
determining data to be provided by a user terminal to a motor vehicle;
detecting an approach of the user terminal to the motor vehicle, wherein the user terminal comprises a digital access key for the motor vehicle; and
performing an authentication process between the user terminal and the motor vehicle in response to the approach to provide the digital access key to the motor vehicle,
wherein the authentication process includes providing the determined data to the motor vehicle.

10. The method of claim 9, wherein the data is provided from a secure element of the user terminal.

11. The method of claim 9, wherein the data was previously provided by a remote computing device.

12. The method of claim 9, further comprising:
providing the data to a remote computing device.

13. The method of claim 9, wherein the data is not related to the authentication process.

14. The method of claim 9, wherein providing the data includes signing the data.

15. The method of claim 9, further comprising:
storing the data in a memory area designated for the digital access key.

16. A Device for data exchange between a motor vehicle and a user terminal, wherein the device comprises means for performing a method according to claim 9.
